(19) United States
(12) Patent Application Publication
(10) Pub. No.: US 2003/0108716 A1
(43) Pub. Date: Jun. 12, 2003

(54) Light-scattering materials which have self-cleaning surfaces

(75) Inventors: Edwin Nun, Billerbeck (DE); Markus Oles, Hattingen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: CREAVIS Gesellschaft fuer Tech. und innovation mbH, Marl (DE)

(21) Appl. No.: 10/309,297

(22) Filed: Dec. 4, 2002

(30) Foreign Application Priority Data
Dec. 6, 2001 (DE) 101 60 054.2

(51) Int. Cl. B32B 1/00; B05D 5/06

(52) U.S. Cl. 428/141; 427/164; 427/180

(57) ABSTRACT

A light-scattering material includes a coating with self-cleaning properties on a transparent substrate. Particles randomly distributed in and on the coating roughen the coating and provide a surface structure that scatters light. The light-scattering material is useful in providing indirect illumination, particularly using daylight. The coating can have antimicrobial properties. The light-scattering material can require significantly less maintenance than conventional light-scattering materials.

### BACKGROUND OF THE INVENTION

1. Field of the Invention

The present invention relates to light-scattering materials which have self-cleaning surfaces, preferably self-cleaning antimicrobial surfaces.

2. Discussion of the Background

There is now a renewed high level of interest in light-scattering materials, since in many instances it is advantageous to provide indoor spaces with daylight where there is no opportunity for direct insolation. For example, some plants do not tolerate direct insolation, and for this reason many greenhouses have not only panes of glass but also mechanical apparatus for cutting out direct insolation.

Similarly, direct insolation through a transparent roof of a conservatory also causes area-specific heating. Occupation by people of areas under roofing systems of this type with changing light conditions and heat conditions can be unpleasant or even hazardous to health.

An example of legislation intended to avoid effects hazardous to health is given by the workplace regulations (ArbStättVO) in Germany, where §7 (ArbStättVO) defines the minimum lighting conditions prescribed for the workplace. Under §9, Section 2 (ArbStättVO) of Oct. 15, 1995, it is a legal requirement that the nature of windows and skylights must be such that, or these must have equipment such that, the interior spaces can be screened from direct insolation.

Diffuse illumination is also advantageous in the livestock husbandry sector. Ideal husbandry of livestock requires relatively high levels of freedom and modified lighting conditions for the animals. If it is impossible to provide free-range conditions, significant improvements can be achieved through well-lit stalls which do not permit direct insolation but require no artificial illumination during prime daylight hours, by using translucent roofing sections for diffuse scattering of the sunlight.

Materials with light-scattering action are well known. For example, flat roofs in particular make use of plastic skylights which are not fully transparent. The surface of these materials is often roughened to achieve the light-scattering effect by means of structuring or matting. This matting may be the result of mechanical action or chemical action, e.g. etching.

A disadvantage of the roughened surfaces is that these surfaces relatively rapidly become opaque (internally and externally) due to particles of dirt or dust, thus reducing the amount of light passing through the material. In addition, wetting with water causes at least partial loss of the light-scattering action. DE 42 18 215 circumvents this disadvantage by producing a light-scattering glass brick which has the roughened surface in its interior. The production of glass bricks of this type is relatively complicated and cannot be adopted for every other possible material.

In an entirely different sector of industry there are known articles with surfaces which are extremely difficult to wet, known as Lotus-effect surfaces, and these have a large number of economically significant features, the surfaces being in particular self-cleaning. Now the cleaning of surfaces is time-consuming and costly. Self-cleaning surfaces are therefore of very great economic interest. The mechanisms of adhesion are generally the result of surface-energy-related parameters acting between the two surfaces which are in contact. These systems generally attempt to reduce their free surface energy. If the free surface energies between two components are intrinsically very low, it can generally be assumed that there will be weak adhesion between these two components. The important factor here is the relative reduction in free surface energy. In pairings where one surface energy is high and one surface energy is low, the crucial factor is very often the opportunity for interactive effects. For example, when water is applied to a hydrophobic surface it is impossible to bring about any noticeable reduction in surface energy. This is evident in that the wetting is poor. The water applied forms droplets with very large contact angles. Perfluorinated hydrocarbons, e.g. polytetrafluoroethylene, have very low surface energy. There are hardly any components which adhere to surfaces of this type, and components deposited on surfaces of this type are in turn very easily removed.

The use of hydrophobic materials, such as perfluorinated polymers, for producing hydrophobic surfaces is known. A further development of these surfaces consists in structuring the surfaces in the μm to nm range. U.S. Pat. No. 5,599,489 discloses a process in which a surface can be rendered particularly repellent by roughening via bombardment with particles of an appropriate size, followed by perfluorination. Another process is described by H. Saito et al. in “Surface Coatings International” 4, 1997, pp. 168 et seq. Here, particles made from fluoropolymers are applied to metal surfaces, whereupon a marked reduction was observed in the wettability of the resultant surfaces with respect to water, with a considerable reduction in tendency toward icing.

There are numerous publications which concern the production of self-cleaning surfaces. By way of example, mention may be made here of U.S. Pat. No. 3,354,022, WO 96/04132, and WO 00/58410. Surfaces of this type are always described and/or claimed for maintaining surface cleanliness, the surface contamination mentioned generally being dusts. When water is set in motion as a result of rain, drizzle, condensation from fog, or artificial sprinkling with water, for example by a water jet from a water hose, the dusts become fixed to the droplets as they roll off and are removed as the droplets roll off the surface. The surfaces may also be transparent materials. However, there is no description of the production or use of light-scattering materials with self-cleaning properties.

EP 1040874 describes self-cleaning surfaces which are transparent if the dimension of the structuring is less than 400 nm and which have high transmittance and, respectively, good optical properties. However, that publication does not describe the phenomenon of light-scattering. The surfaces described in EP 1040874 are obtained at least to some extent by embossing of a periodic structure. These are quite unsuitable for the production of light-scattering materials, since periodic structures can generate interference phenomena rather than diffuse light scattering.

### SUMMARY OF THE INVENTION

The present invention provide light-scattering materials with self-cleaning properties.

Surprisingly, it has been found that it is possible to equip transparent materials with light-scattering properties and with self-cleaning properties if these materials are coated with a random distribution of particles of size from 20 nm to 100 μm.

The present invention therefore provides a light-scattering material based on a transparent material with an artificial surface structure made from elevations and depressions which comprises a specific coating with random distribution of the particles on at least one surface, where the surface structure has light-scattering and self-cleaning properties and has elevations with a height of from 20 nm to 100 μm and with a separation of less than 100 μm between the elevations.

The present invention also provides a process for producing light-scattering materials with an artificial surface structure that have self-cleaning properties, where a specific coating is applied with random distribution of the particles to at least one surface of the material, wherein the surface structure has light-scattering and self-cleaning properties and has elevations with a height of from 20 nm to 100 μm and with a separation of less than 100 μm between the elevations.

The present invention also provides the use of these light-scattering materials for producing skylights, greenhouse glazing, transparent or translucent roofing systems, such as roofing systems for conservatories, bus stops, shopping arcades, railroad stations, or sports stadia, diffusers or illumination units in livestock husbandry, and also provides skylights, greenhouse glazing, diffusers, and illumination units for livestock husbandry which comprise these light-scattering materials.

### BRIEF DESCRIPTION OF THE DRAWINGS

The preferred embodiments of this invention will be described in detail with reference to the following figures, wherein:

FIG. 1 shows a photo of a shadowing test;

FIG. 2 shows a photo of a shadowing test; and

FIG. 3 shows a photo of a shadowing test.

### DETAILED DESCRIPTION OF PREFERRED EMBODIMENTS

The principal property of the materials of the invention—alongside the self-cleaning described and the possible inhibition of microorganism growth—is that they scatter light diffusely. When glass roofs are coated with films which have been embossed to give them self-cleaning properties, interference can be produced leading to local overheating and in turn to the death of some sections of plants in greenhouses. The materials of the invention have the advantage of avoiding this disadvantageous production of interference, by using a random distribution of the particles and thus obtaining a non-periodic surface structure. If the materials of the invention have hydrophobic and self-cleaning properties, the formation of water films on the surface is also inhibited, and the transparency which arises on the wetting of surfaces mattened by roughness and wetting by water occurs is never, or only seldom, found with the surfaces of the present invention.

The materials of the invention with self-cleaning anti-microbial properties, treated so that the particles secured to the surface scatter light and can therefore act as diffusers, comply with the requirements of ArbStättVO.

The materials of the invention are described in more detail below, but there is no intention that the surfaces be restricted to this description. The light-scattering materials of the invention are based on transparent materials with a synthetic surface structure made from elevations and depressions, which comprises a specific coating with random distribution of the particles on at least one surface, the surface structure having light-scattering and self-cleaning properties, and are distinguished by the fact that the surface structure has elevations with a height of from 20 nm to 100 μm and with a separation of less than 100 μm between the elevations.

Particularly good self-cleaning properties are achieved in combination with good light-scattering properties if the surface structure has hydrophobic elevations with a height of from 50 nm to 20 μm, preferably from 100 nm to 10 μm, and very particularly preferably from 0.1 to 5 μm, and with a separation of less than 100 μm, preferably with a separation of from 50 nm to 75 μm, and very particularly preferably from 500 nm to 5 μm.

It can be advantageous for the coating to have antimicrobial properties. Inventive materials of this type with antimicrobial properties have the advantage that the period over which articles produced therefrom transmit a constant amount of diffuse light is longer than for conventional articles, since soiling of the surface, and therefore of the area which transmits light, proceeds significantly more slowly. The reason for this is that the adhesion and spread of biological contamination, e.g. bacteria, fungi, and algae, is significantly slowed, and there is therefore longer retention of the effective self-cleaning properties of the light-scattering material surface. The antimicrobial properties are preferably achieved due to the presence of at least one material with antimicrobial properties in the coating. Particularly suitable materials of this type are homo- or copolymers of 2-tertbutylaminoethyl methacrylate, 2-diethylaminoethyl methacrylate, 2-diethylaminomethyl methacrylate, 2-tertbutylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyidimethylammonium bromide, 2-methacryloyloxyethyl-4-benzoyldimethylammonium bromide, 2-acrylamido-2-methyl-1-propanesulfonic acid, 2-diethylaminoethyl vinyl ether, or 3-aminopropyl-vinyl ether.

The elevations and depressions of the surface structure are formed by applying, to the surface of the material, a coating which comprises a random distribution of particles. The method of securing the particles to the surface is preferably the use of a carrier system, and this carrier system has to be transparent or diffusely transparent or translucent. The particles are preferably hydrophobic particles. However, it can also be advantageous for the particles to be a mixture of hydrophobic particles and particles with antimicrobial properties. The surface very particularly preferably has a mixture of hydrophobic particles and particles with antimicrobial properties, comprising from 0.01 to 25% by weight, preferably from 0.1 to 20% by weight, very particularly preferably from 1 to 15% by weight, content of particles with antimicrobial properties, based on the mixture of particles.

It is preferable to use hydrophobic or hydrophobicized particles with diameters from 0.02 to 100 μm, particularly preferably from 0.2 to 50 μm, and very particularly preferably from 0.3 to 30 μm. The surface structures of the invention have separations of from 0 to 10 particle diameters, in particular from 0 to 3 particle diameters, between the separate particles on the surface. The diameters of the antimicrobial, hydrophilic particles may preferably be from 1 to 2000 μm, with preference from 2 to 1000 μm or from 20 to 2000 μm, and very particularly preferably from 50 to 500 μm.

For very substantial avoidance of interference, it can be advantageous for the surface structure to be formed by particles or, respectively, particle fractions which have differing particle sizes or particle diameters. The surface structure preferably has at least two particle fractions whose average particle size differs by a factor of from 2 to 10, preferably by a factor of from 4 to 7. Care has to be taken here that the distribution of the particles is preferably not very sharp-edged.

For avoidance of interference phenomena at the surfaces, it is particularly advantageous for there to be a broad particle size distribution. If the particles here have distribution of from 0.1 to 2 μm the production of interference phenomena at the surface is almost completely avoided. It is of subordinate importance here whether the particle size is produced by agglomeration of primary particles or by variations in primary particles sizes.

The particles may also be present in the form of aggregates or agglomerates, where, according to DIN 53 206, aggregates have primary particles in edge- or surface-contact, while agglomerates have primary particles in point-contact. The particles used may also be those formed by combining primary particles to give agglomerates or aggregates whose size is from 0.2 to 100 μm. An average diameter of the primary particles can be from 5 to 50 nm.

It can be advantageous for the hydrophobic or hydrophobicized particles used to have a structured surface. The particles preferably used here are those which have an irregular fine nanostructure on the surface. The fine structure of the particles is preferably a fissured structure with elevations and/or depressions in the nanometer range. The average height of the elevations is preferably from 20 to 500 nm, particularly preferably from 50 to 200 nm. The separation between the elevations and, respectively, depressions on the particles is preferably less than 500 nm, very particularly preferably less than 200 nm. These depressions, e.g. craters, crevices, notches, clefts, apertures, or cavities, reinforce the effectiveness of the particle structure. Other structural features, such as undercuts in the depressions or combinations of the various depressions, raise effectiveness.

Hydrophobic particles which may be used are transparent and/or translucent particles which comprise at least one material selected from the group consisting of silicates, doped or fumed silicates, minerals, metal oxides, silicas, and polymers. The particles, in particular hydrophobic particles, used which have an irregular fine nanostructure on the surface are preferably particles which comprise at least one compound selected from the group consisting of fumed silica, aluminum oxide, silicon oxide, mixed oxides, fumed silicates, and pulverulent polymers. It can be advantageous for the surface of the invention to comprise particles which have hydrophobic properties. The hydrophobic properties of the particles may be inherently present by virtue of the material used for the particles. However, it is also possible to use hydrophobicized particles, e.g. those which have hydrophobic properties by virtue of treatment with at least one compound selected from the group consisting of alkylsilanes, perfluoroalkylsilanes, paraffins, waxes, fatty esters, functionalized long-chain alkane derivatives, and alkyldisilazanes.

The particles used with antimicrobial properties and generally having hydrophilic properties are preferably those which comprise homo- or copolymers selected from the group consisting of 2-tert-butylaminoethyl methacrylate, 2-diethylamino ethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxy ethyltrimethylammonium methosulfate, 2-diethylaminoethyl methacrylate, 2-methacryloyloxyethyltrimethylammonium chloride, 3-methacryloyl aminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

The material of the invention or its surface may be at least one area of a molding made from a transparent or diffusely transparent material selected from the group consisting of polymers, e.g. polyamides, polyesteramides, polyvinyl chloride, polystyrenes, polycarbonates, polyolefins, polysilicones, polysiloxanes, polymethyl methacrylates, polyterephthalates, and mineral glasses. The list of polymeric materials is merely given by way of example, and the materials are not restricted to those listed. Copolymers and polymer blends which have transparent appearance are expressly claimed. If the molding is a molding made from a polymer, it can be advantageous for this molding and therefore the surface to comprise a polymer with antimicrobial properties.

Materials of the invention may be either semifinished products or molded articles or items, films, sheets, plates, or the like. The light-scattering material of the invention may have one-, two-, or multi-sided surfaces with surface structures which have self-cleaning and light-scattering properties.

The materials of the invention are preferably produced by the process of the invention for producing light-scattering materials with an artificial surface structure which has light-scattering and self-cleaning properties. This process produces a surface structure which has elevations with a height of from 20 nm to 100 μm and with a separation of less than 100 μm between the elevations by applying a specific coating with random distribution of the particles to at least one surface of the material. The application of the coating and the securing of the particles to the surface may take place in a manner known to the skilled worker. An example of a chemical method which may be used for the securing process is the use of a carrier system. Carrier systems which may be used are various adhesives, or adhesion promoters, or lacquers. Other carrier systems or chemical fixing methods will be apparent to the skilled worker.

It can be advantageous for at least one material which has antimicrobial properties to be used during the production of the surface structures.

The material which has antimicrobial properties may be present in the surface of the material and also in the carrier system or particle system. At least some of the particles used preferably comprise a material which has antimicrobial properties. The antimicrobial material used is preferably a homo- or copolymer prepared from 2-tert-butylaminoethyl methacrylate, 2-diethylaminoethyl methacrylate, 2-diethylaminomethyl methacrylate, 2-tertbutylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, or 3-aminopropyl vinyl ether.

It is very particularly preferable for a particle mixture which comprises particles with antimicrobial properties to be applied to the surface. It can be advantageous for the particle mixture to comprise a mixture of structure-forming, preferably hydrophobic particles and particles with antimicrobial properties which, based on the particle mixture, has from 0.01 to 25% by weight, preferably from 0.1 to 20% by weight, and very particularly preferably from 1 to 15% by weight, content of particles with antimicrobial properties. The particles with antimicrobial properties may, of course, likewise contribute to structure-forming. The particle mixture has to be balanced in such a way as to generate the antimicrobial activity but retain the dominance of the hydrophobic properties needed for self-cleaning.

An example of a method for applying the particle mixture to the surface to generate the surface structure and the antimicrobial properties is that the carrier system, which may be a curable substance, is applied to a surface by spray, doctor, spreader, or jet. The thickness preferably applied of the curable substance is from 1 to 200 μm, preferably from 5 to 75 μm. Depending on the viscosity of the curable substance, it can be advantageous to permit the substance to begin to cure before applying the particles. Ideally, the selected viscosity of the curable substance is such as to permit the particles applied to sink at least to some extent into the curable substance, but to prevent flow of the curable substance and, respectively, of the particles applied thereto when the surface is placed vertically.

An example of the method for applying the particles is spray-application. In particular, the particles may be applied by spray-application using an electrostatic spray gun. Once the particles have been applied, excess particles, i.e. particles not adhering to the curable substance, may be removed from the surface by shaking, or by being brushed off or blown off. These particles may be collected and reused.

In the preferred embodiment of the process of the invention, the fixing of the particles to the surface takes place by way of curing of the carrier system, preferably brought about by the energy in heat and/or light. The curing of the carrier system is particularly preferably brought about by the energy in light. The curing of the carrier preferably takes place in an inert gas atmosphere, very particularly preferably in a nitrogen atmosphere.

The carrier system has to be transparent or diffusely transparent or translucent. Particular carrier systems which may be used are UV-curable, thermally curable, or air-curing coating systems. Coating systems include lacquer-like mixtures made from monounsaturated acrylates or methacrylates with polyunsaturated acrylates or methacrylates, and also mixtures of polyunsaturated acrylates or, respectively, methacrylates with one another. Urethane-based lacquer systems are also valid coating systems. The mixing ratios may be varied within wide limits. Depending on the structure-forming component to be added subsequently, other functional groups may be added, for example hydroxy groups, ethoxy groups, amines, ketones, isocyanates, or the like, or else fluorine-containing monomers or inert filler components, such as polymers soluble in a monomer mixture. The additional functionality serves mainly to improve binding of the structure-formers. Other carrier systems which may be used are straight acrylate dispersions and PU lacquer systems (polyurethane lacquer systems). It can be advantageous for the carrier system likewise to comprise a material which has antimicrobial properties.

The structure-forming particles used may be hydrophobic or hydrophobicized particles which comprise at least one transparent and/or translucent material selected from the group consisting of silicates, doped or fumed silicates, minerals, metal oxides, silicas, and polymers, in the form of aggregate or agglomerate. Particular preference is given to the concomitant use of particles whose particle diameter is from 0.02 to 100 μm, particularly preferably from 0.1 to 50 μm, and very particularly preferably from 0.3 to 30 μm. It can be advantageous to use mixtures of particles with at least two fractions of particles with different particle sizes. This method prevents any regular arrangement of equal-size particles, leading to interference phenomena. It is preferable to use at least two fractions whose average particle size differs by a factor of from 2 to 10, preferably by a factor of from 4 to 7. Of course, it is also possible for the particles used to comprise one or more particle fractions which have particles of different sizes. A broad particle size distribution is particularly advantageous for avoiding interference phenomena at the surfaces. Interference phenomena at the surface here are almost completely avoided using a particle distribution of from 0.1 to 2 μm. It is of subordinate significance here whether the particle size is produced by agglomerating primary particles or by variation in primary particle sizes.

The particles for generating the self-cleaning surfaces preferably have hydrophobic properties. The particles may themselves be hydrophobic, e.g. particles comprising PTFE, or the particles used may have been hydrophobicized. The hydrophobicization of the particles may take place in a manner known to the skilled worker, e.g. by way of treatment with at least one compound selected from the group consisting of alkylsilanes, perfluoroalkylsilanes, paraffins, waxes, fatty esters, functionalized long-chain alkane derivatives, and alkyldisilazanes. Examples of typical hydrophobicized particles are very fine powders, such as Aerosil R 974 or Aerosil R 8200 (Degussa AG), which are available for purchase.

The hydrophobic, transparent and/or translucent particles used or the subsequently hydrophobicized, transparent and/or translucent particles used are preferably those which comprise at least one material selected from the group consisting of silicates, doped silicates, minerals, metal oxides, mixed metal oxides, fumed silicas, precipitated silicas, and polymers. The particles very particularly preferably comprise silicates, fumed silicas or precipitated silicas, in particular Aerosils, SiO₂, TiO₂, ZrO₂ or pulverulent polymers, e.g. cryogenically milled or spray-dried polytetrafluoroethylene (PTFE).

It is particularly preferable to use transparent hydrophobic particles with a BET surface area of from 50 to 600 m²/g It is very particularly preferable to use particles which have a BET surface area of from 50 to 200 m²/g.

The particles used with antimicrobial properties may be particles which comprise homo- or copolymers prepared from 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminoproylacrylamide, 2-methacryloyloxyethyltrimethylamonium methosulfate, 2-diethylaminoethyl methacrylate, 2-methacryloyloxyethyltrimethylammonium chloride, 3-methacryloylaminoproyltrimethylammonium chloride, 2-methacryloyloxyethyltrimethylammnium chloride, 2-acryloyloxyethyl-4-benzoyldimethylammoium bromide, 2-ethacryloyloxyethyl-4-benzoyldimethylammonium bromide, 2-acrylamido-2-methyl-1-propanesulfonic acid, 2-diethylaminoethyl vinyl ether, or 3-aminopropylvinyl ether. The particles may be composed entirely of the material having antimicrobial properties, or have a coating of the antimicrobial material. It is particularly preferable to use particles which have antimicrobial properties and whose diameter from 1 to 2000 μm, particularly preferably from 20 to 1000 μm, and very particularly preferably from 5 to 500 μm.

The particles with antimicrobial action are preferably not hydrophobicized, since occupation of the surface by a hydrophobicizing reagent causes loss of the antimicrobial property.

The particles may also be present in the form of aggregates or agglomerates, where, according to DIN 53 206, aggregates have primary particles in edge- or surface-contact, while agglomerates have primary particles in point-contact. The particles used may also be those formed by combining primary particles to give agglomerates or aggregates whose size is from 0.2 to 100 μm.

It can be advantageous for the particles used to have a structured surface. The particles preferably used here are those which have an irregular fine nanostructure on the surface. The fine structure of the particles is preferably a fissured structure with elevations and/or depressions in the nanometer range. The average height of the elevations is preferably from 20 to 500 nm, particularly preferably from 50 to 200 nm. The separation between the elevations and, respectively, depressions on the particles is preferably less than 500 nm, very particularly preferably less than 200 nm. Depressions, e.g. craters, crevices, notches, clefts, apertures, or cavities, reinforce the effectiveness of the particle structure. Combinations of the depressions, and also further structural elements in the form of undercuts, are particularly preferred, as they increase the effectiveness of the surfaces of the invention.

The starting material used or the starting surface used of a material may be at least one area of a molding made from a transparent of diffusely transparent material selected from the group consisting of polymers, e.g. polyamides, polyurethanes, polyether block amides, polyesteramides, polyvinyl chloride, polyolefins, polysilicones, polysiloxanes, polymethyl methacrylates, polyterephthalates, and mineral glasses. The list of polymeric materials is given only by way of example and the materials are not restricted to those listed. If the molding is a molding made from polymers, it can be advantageous for this molding and therefore for the surface to comprise a polymer with antimicrobial properties. Moldings of the invention may be either semifinished products, molded articles or items, films, sheets, plates, or the like. The process of the invention may be used to generate light-scattering materials of the invention, one, two, or more sides of which have been provided with surface structures which have self-cleaning and light-scattering properties.

The process of the invention gives excellent results in producing light-scattering materials with self-cleaning properties. Examples of the uses of these light-scattering materials are roofs of greenhouses, transparent or translucent roofing systems, such as roofing systems of conservatories, bus stops, shopping arcades, railroad stations, or sports stadia. The light-scattering materials of the invention with random distribution of the particles in particular have the advantage that they ensure uniform light distribution over the entire surface provided with the surface structure on the material. Unlike conventional greenhouses which have to be cleaned regularly to remove, inter alia, foliage and dust, and also biological material, e.g. algae, greenhouses made from a material of the invention can be operated with longer intervals between cleaning.

The material of the invention may therefore be used as skylight, transparent or translucent roofing systems, such as roofing systems of conservatories, bus stops, shopping arcades, railroad stations, or sports stadia, greenhouse glazing, or for producing skylights and greenhouse glazing. The advantages mentioned are in particular possessed by transparent or translucent roofing systems or glazing which comprise a material of the invention.

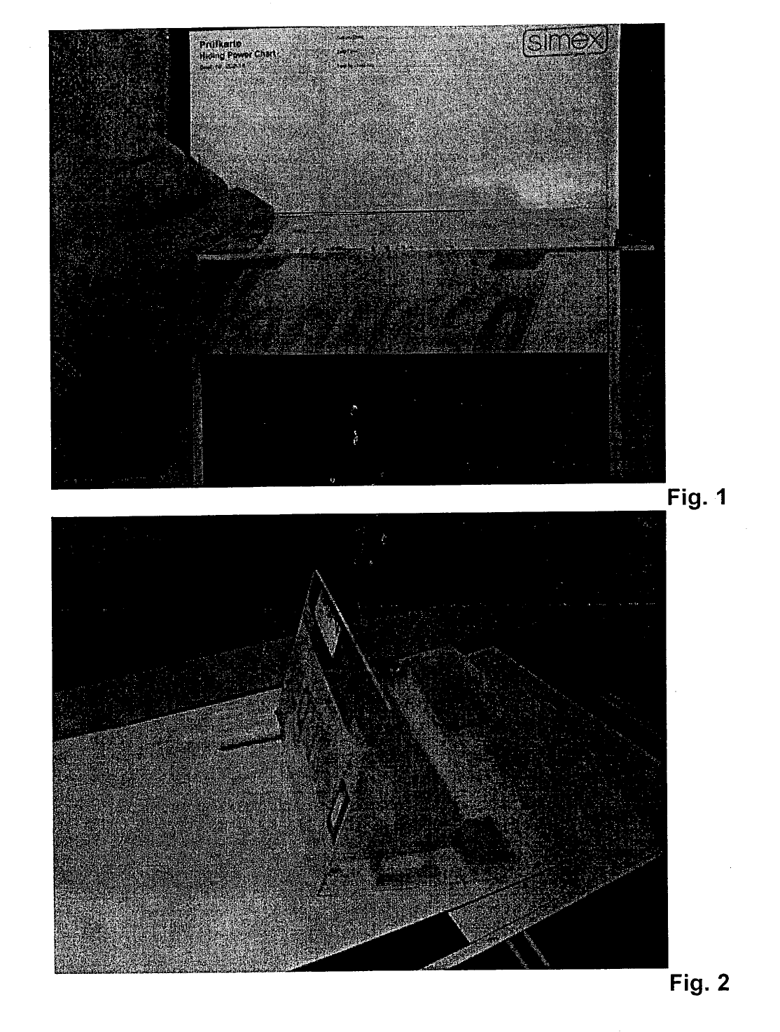

FIGS. 1-3 provide further illustration of the invention, but there is no intention that the invention be restricted to those embodiments.

FIG. 1 shows a photo of a shadowing test as in Comparative Example 2. It can clearly be seen that the inscription produces a legible shadow.

FIG. 2 shows a photo of the shadowing test as in Example 2. It can clearly be seen that the inscription does not produce any legible shadow at locations where the sheet had been treated according to the invention.

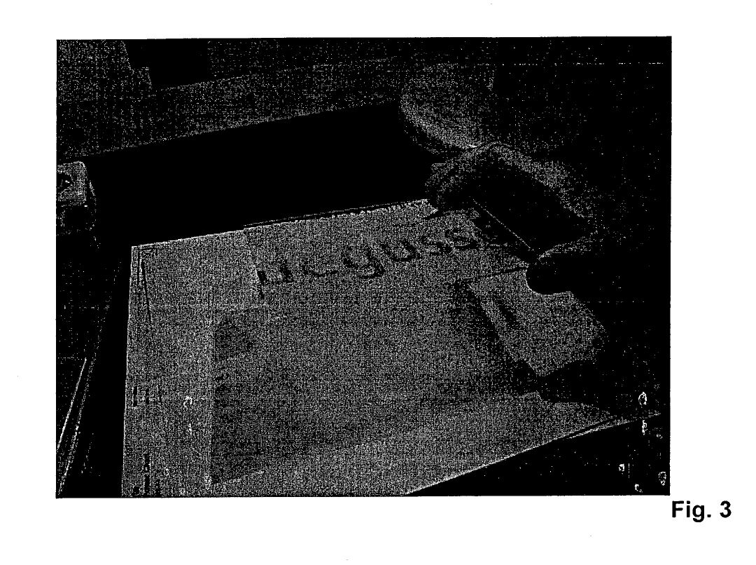

FIG. 3 shows another photo of the shadowing test in Example 2. It can clearly be seen that the inscription does not produce any legible shadow.

The examples below provide further illustration of the material of the invention, and also a process for its production, but there is no intention that the invention be restricted to these examples.

### EXAMPLE 1

20% by weight of methyl methacrylate, 20% by weight of pentaerythritol tetraacrylate, and 60% by weight of hexanediol dimethacrylate were mixed with one another. Based on this mixture, 14% by weight of Plex 4092 F, an acrylic copolymer from Röhm GmbH, and 2% by weight of Darokur 1173 UV curing agent were added and the mixture was stirred for at least 60 min. The highly-crosslinking, UV-curable acrylate mixture was applied at a thickness of 10 μm to an extruded polymethyl methacrylate sheet of thickness 3 mm, and then Aerosil R 8200 particles were applied by electrostatic coating. This lacquer/particle coating was cured by means of UV radiation at wavelength 308 nm, under nitrogen.

Shadowing was Assessed as Follows:

The coated PMMA sheet was irradiated from above using a light source. A rod-shaped molding was placed on the sheet, and the sheet with the superimposed molding was moved away from the light source in the direction of the table surface. The table surface had been covered with white paper. Initially, no profile of any type was discernible. As the white paper was approached, an area on the paper began to appear somewhat darker, but completely shapeless. No sharp shadowing was discernible even on very close proximity to the white paper.

### Comparative Example 1

The acrylate mixture from Example 1, but without particles, was applied to a PMMA sheet and cured.

When a rod-shaped article was superimposed, a sharply delineated region of shadow was produced at all distances from the light source.

### EXAMPLE 2

20% by weight of methyl methacrylate, 20% by weight of pentaerythritol tetraacrylate, and 60% by weight of hexanediol dimethacrylate were mixed with one another. Based on this mixture, 14% by weight of Plex 4092 F, an acrylic copolymer from Röhm GmbH, and 2% by weight of Darokur 1173 UV curing agent were added and the mixture was stirred for at least 60 min. The highly-crosslinking, UV-curable acrylate mixture was applied at a thickness of 10 μm to an extruded polymethyl methacrylate sheet of thickness 3 mm, and then Aerosil R 8200 particles were applied by electrostatic coating. This lacquer/particle coating was cured by means of UV radiation at wavelength 308 nm, under nitrogen.

Shadowing was Assessed as Follows:

An inscription was applied to that side of the sheet opposite to the coating. A light source was then used to irradiate the coated PMMA sheet obliquely from above. No legible shadow of the inscription could be observed (FIG. 2). FIG. 3 shows another photo of the shadowing test.

### Comparative Example 2

The experiment of Example 2 was repeated, but no particles were applied to the PMMA sheet. In the shadowing test a legible shadow of the inscription was observed (FIG. 1).

Obviously, numerous modifications and variations of the present invention are possible in light of the above teachings. It is therefore to be understood that within the scope of the appended claims, the invention may be practiced otherwise than as specifically described herein.

The disclosure of the priority document, Application No. 101 60 054.2, filed in Germany on Dec. 6, 2001, is incorporated by reference herein in its entirety.

What is claimed is:

1. A light-scattering material comprising
a transparent material; and
a coating on the transparent material, wherein
the coating includes
particles randomly distributed on at least one surface of the coating, and
a surface structure having light-scattering and self-cleaning properties; and
the surface structure includes elevations and depressions, where the elevations are separated from each other by less than 100 μm and each of the elevations has a height of from 20 nm to 100 μm.

2. The light-scattering material as claimed in claim 1, wherein the coating has antimicrobial properties.

3. The light-scattering material as claimed in claim 2, wherein the coating comprises at least one antimicrobial polymer that has been prepared from at least one monomer selected from the group consisting of 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylamino propylmethacrylamide, diethylaminopropylmethacrylamide, N-3-dimethylaminopropylacrylamide, 2-methacryloyloxy ethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxy ethyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

4. The light-scattering material as claimed in claim 1, wherein the particles are fixed to the at least one surface of the coating by means of a carrier system.

5. The light-scattering material as claimed in claim 1, wherein the particles comprise a mixture of hydrophobic particles and particles with antimicrobial properties.

6. The light-scattering material as claimed in claim 5, wherein the particles with antimicrobial properties comprise at least one antimicrobial polymer that has been prepared from at least one monomer selected from the group consisting of 2-tert-butylaminoethyl methacrylate, 2-diethylaminoethyl methacrylate, 2-diethylaminomethyl methacrylate, 2-tertbutylaminoethyl acrylate, 3-dimethylaminopropyl acrylate, 2-diethylaminoethyl acrylate, 2-dimethylaminoethyl acrylate, dimethylamino propylmethacrylamide, diethylaminopropylmethacrylamide, N-3-dimethylaminopropylacrylamide, 2-methacryloyloxy ethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxy ethyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

7. The light-scattering material as claimed in claim 5, wherein the content of the particles with antimicrobial properties in the mixture is from 0.01 to 25% by weight, based on the mixture.

8. The light-scattering material as claimed in claim 1, wherein the transparent material is selected from the group consisting of polymers and mineral glasses.

9. The light-scattering material as claimed in claim 8, wherein the polymers are selected from the group consisting of polyamides, polyesteramides, polycarbonates, polystyrenes, polyvinyl chloride, polyolefins, polysilicones, polysiloxanes, polymethyl methacrylates, polyterephthalates, and polymer blends thereof.

10. A process for producing light-scattering materials, the process comprising
applying a coating containing randomly distributed particles to at least one surface of a transparent material to generate a surface structure including elevations and depressions, where the elevations are separated from each other by less than 100 μm and each of the elevations has a height of from 20 nm to 100 μm; and
producing the light-scattering material of claim 1.

11. The process as claimed in claim 10, wherein the applying comprises generating the surface structure using at least one material having antimicrobial properties.

12. The process as claimed in claim 10, wherein the applying comprises fixing the particles to a surface of the coating to form the surface structure.

13. The process as claimed in claim 12, wherein the particles are fixed to the surface of the coating using a carrier system.

14. The process as claimed in claim 13, wherein at least one of the particles and the carrier system comprises an antimicrobial material.

15. The process as claimed in claim 14, wherein the antimicrobial material comprises a polymer that has been prepared from at least one monomer selected from the group consisting of 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethyl aminoethyl acrylate, dimethylaminopropylmethacrylamide, diethylaminopropylmethacrylamide, N-3-imethylaminopropylacrylamide, 2-methacryloyloxyethyltrimethylammonium methosulfate, 2-diethylaminoethylmethacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyidimethylammonium bromide, 2-methacryloyloxyethyl-4-benzoyldimethylammonium bromide, 2-acrylamido-2-methyl-1-propane sulfonic acid, 2-diethylaminoethyl vinyl ether, and 3-aminopropyl vinyl ether.

16. The process as claimed in claim 10, wherein the particles comprise a mixture of
transparent or translucent particles including at least one material selected from the group consisting of silicates, doped silicates, minerals, metal oxides, silicas, and polymers; and
homo- or copolymer particles prepared from at least one monomer selected from the group consisting of 2-tert-butylaminoethylmethacrylate, 2-diethylaminoethyl methacrylate, 2-diethylaminomethyl methacrylate, 2-tertbutylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxy-ethyltrimethylammonium methosulfate, 2-diethylaminoethyl methacrylate, 2-methacryloyloxyethyltrimethylammonium chloride, 3-methacryloyl-aminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

17. The process as claimed in claim 10, wherein
the particles comprise at least one of agglomerates and aggregates of primary particles; and
an average diameter of the primary particles is from 5 to 50 nm.

18. The process as claimed in claim 14, wherein
the particles comprise the antimicrobial material; and
each of the particles has a diameter in a range of from 20 to 2000 μm.

19. The process as claimed in claim 10, wherein the particles include a particle surface having an irregular nanostructure.

20. A method of using a light-scattering material, the method comprising constructing with the light-scattering material of claim 1 a skylight; a greenhouse glazing; a transparent or translucent roofing system for a conservatory, a bus stop, a shopping arcade, a railroad station, or a sports stadium; an illumination unit for animal husbandry; or an animal cage.

21. A skylight which comprises the light-scattering material of claim 1.

22. Glazing which comprises the light-scattering material of claim 1.
